(19) United States
(12) Patent Application Publication
(10) Pub. No.: US 2026/0138350 A1
(43) Pub. Date: May 21, 2026

(54) APPARATUS AND METHOD FOR FORMING A PROTECTIVE PORTION FROM A BLANK

(71) Applicant: SYSTEM CERAMICS S.p.A., Fiorano Modenese (IT)

(72) Inventors: Stefano SORRENTINO, Fiorano Modenese (IT); Marco SALVÀ, Fiorano Modenese (IT); Luca CARBONI, Bologna (IT); Vincenzo MARTINO, Fiorano Modenese (IT)

(21) Appl. No.: 19/389,637

(22) Filed: Nov. 14, 2025

(30) Foreign Application Priority Data
Nov. 15, 2024 (IT) 102024000025821

(51) Int. Cl. B31D 5/04

(52) U.S. Cl. CPC B31D 5/04

(57) ABSTRACT

An apparatus for forming a protective portion from a blank. The apparatus comprises a lying plane for the blank; a retainer switchable to an operating condition in which it retains the blank at a retaining portion. The retainer is movable on a movement plane perpendicular to the lying plane. The retainer is rotatable around a rotation axis perpendicular to the movement plane. The rotation axis passes through the retaining portion. The retainer is configured to translate along circular arcs on the movement plane while rotating around the rotation axis and while it is in the operating condition, actuating a folding of the blank. A relative method of forming a protective portion from a blank.

### TECHNICAL FIELD

The present invention relates to an apparatus for forming a protective portion from a blank and to a method for forming a protective portion from a blank.

The present invention finds a preferred application in the sector of commerce, where a box is used as packaging to contain one or more articles, for example for sale and/or shipment.

### BACKGROUND

Some types of packaging boxes comprise a protective portion, formed as a folding of a blank portion on itself. This folded blank portion constitutes a kind of roll that is actually the protective portion.

In the Applicant's experience, the protective portion gives the packaging a better ability to protect an article contained in the box, especially during shipment.

In fact, the protective portion can absorb any inertial forces acting on the box, for example due to impacts or falls.

In the Applicant's experience, a protective portion may comprise a polygonal, in particular rectangular, structure. Within the polygonal structure, a reinforcing element may be present. Said reinforcing element can be a blank portion positioned diagonally inside the polygonal structure, defining the hypotenuse of a triangle.

The Applicant has verified that during the folding of a blank portion on itself there is an elastic return of the material of the blank, which tends to unwind the protective portion, making it difficult to form it.

The Applicant has also noted that the bonding of the protective portion in its desired configuration is particularly complex because, if the various elements of the protective portion are not folded exactly, an unwanted and permanent bonding of elements in incorrect positions may occur.

In the Applicant's experience, in order to guarantee the due folding precision of the elements of the protective portion against the elastic return of the material of the blank, the protective portion is made by operators, folding the blank manually.

However, the Applicant has verified that this involves processing times that may be too long and high production costs.

The Applicant has perceived that an automated system could perform a folding operation of the protective portion more quickly and economically.

The Applicant has perceived that an automated system for folding the protective portion should have movable operating elements that accompany and accurately position the elements of the blank, which must be folded to form the protective portion.

The Applicant has therefore found that by retaining the blank at a portion thereof and by moving this portion along appropriate trajectories around folding lines of the blank, it is possible to perform the folding of the protective portion in a repeatable and accurate manner.

### SUMMARY

The present invention therefore relates, in a first aspect thereof, to an apparatus for forming a protective portion from a blank.

Preferably, there is provided a lying plane for the blank.

Preferably, there is provided a retainer switchable to an operating condition.

Preferably, in the operating condition the retainer retains the blank at a retaining portion thereof.

Preferably, the retainer is movable on a movement plane perpendicular to the lying plane.

Preferably, the retainer is rotatable around a rotation axis perpendicular to the movement plane.

Preferably, the rotation axis of the retainer passes through the retaining portion.

Preferably, the retainer is configured to translate along circular arcs on the movement plane, while rotating around the rotation axis and while it is in the operating condition.

Preferably, the retainer performs a folding of the blank.

The Applicant considers that, by means of the movement of the retainer along the circular arcs and the simultaneous rotation of the retainer around the rotation axis, the folding of the blank takes place in compliance with the folding lines provided for the blank, avoiding twisting or unwanted deformation of the material that constitutes the blank. In this way, the protective portion is folded quickly and accurately, reaching a high degree of quality.

The present invention relates, in a second aspect thereof, to a method of forming a protective portion from a blank.

Preferably, it is provided for identifying a plurality of folding lines of the blank, parallel to each other.

Preferably, it is provided for retaining the blank by means of a retainer, at a retaining portion of the blank.

Preferably, it is provided for moving the retainer along a plurality of successive circular arcs having respective centres at the folding lines.

Preferably, simultaneous to moving the retainer along each circular arc of the plurality of circular arcs, each circular arc having a respective centre, it is provided for rotating the retainer around a rotation axis which remains parallel to a folding line of the plurality of folding lines, the folding line being at the respective centre.

Preferably, the rotation axis is passing through the retaining portion of the blank.

By the expression "lying plane" is meant a surface composed of one or more partial surfaces, continuous or discontinuous with each other, and substantially approximable by means of a plane.

By the expression "movable on a plane" is meant that a three-dimensional object has an own section that translates while remaining on a particular plane, during a movement or a part of movement of the object itself in space.

By the expression "folding lines" are meant segments of straight lines, physical or imaginary, along which a blank is to be folded; these folding lines can be weakenings in the material of the blank, shaped like a straight line, made for example by creasing. A folding line can for example act as a hinge line along which a blank is folded.

By the expression "centre" of a circular arc is meant the centre of a circumference to which the circular arc itself belongs.

By the expression "paper material" is meant a material based on paper or paper pulp, in the form of individual sheets or panels or sheets or panels that are superimposed or interspersed with one or more corrugated sheets or panels, in which the weight to surface ratio (grammage) is comprised between about 80 g/m² and about 1000 g/m².

The present invention may have at least one of the preferred features described below. Such preferred features may be present individually or in combination with each other, unless expressly stated otherwise, both in the apparatus and in the method according to the present invention.

Preferably, the blank is folded on itself to form the protective portion, lifting the blank into a space delimited by one side of the lying plane.

Preferably, the blank comprises paper material.

Preferably the blank comprises between two and six folding lines.

Preferably, the blank comprises at least three folding lines.

Preferably, the blank comprises five folding lines.

Preferably, the movement plane is perpendicular to the folding lines of the blank.

Preferably, the plurality of folding lines defines a respective plurality of panel elements of the blank.

Preferably, a panel element of the plurality of panel elements comprises a panel adhesion portion.

Preferably, the panel adhesion portion comprises an adhesive strip. Preferably, the adhesive strip comprises a hot melt glue and/or a water-based adhesive.

Preferably, it is provided for applying the panel adhesion portion on the blank before folding the protective portion.

Alternatively and equally preferably, it is provided for applying the panel adhesion portion on the blank while folding the protective portion. In this case, preferably, it is provided for applying the panel adhesion portion on the blank before folding a last panel element of the plurality of panel elements of the protective portion.

Preferably, it is provided for applying the panel adhesion portion by means of one or more gluing devices.

Preferably, the panel adhesion portion is parallel to the folding lines of the blank.

Preferably, the panel adhesion portion is applied to a base panel element of the plurality of panel elements.

Preferably, the base panel element is positioned between a last folding line of the blank and an outer edge.

Preferably, the base panel element is positioned between the last folding line and the outer edge, without further folding lines being interposed between the base panel element and the outer edge.

Preferably, the base panel element has a surface area greater than a surface area of any other panel element of the blank.

Preferably, the retaining portion is positioned in a first panel element, defined by the first folding line and by the outer edge of the blank. In an alternative and equally preferred embodiment, the retaining portion is positioned in a second panel element, defined by the first folding line and by a second folding line opposite the outer edge of the blank with respect to the first folding line.

Preferably, it is provided for adhering a panel element of the blank onto the panel adhesion portion, to fix a structure of the protective portion.

Preferably, the panel element adhering on the panel adhesion portion is positioned in the protective portion parallel to the lying plane.

Preferably, the blank comprises a reinforcing panel element among the plurality of panel elements.

Preferably, the reinforcing panel element is folded diagonally in a section of the protective portion in the movement plane.

Preferably, the retaining portion belongs to the reinforcing panel element.

Preferably, the reinforcing panel element is positioned between a first folding line and an outer edge of the blank.

Preferably, the reinforcing panel element is positioned between the first folding line and the outer edge, without further folding lines being interposed between the reinforcing panel element and the outer edge.

Preferably, the reinforcing panel element corresponds to a first panel element, defined by the first folding line and by the outer edge of the blank.

In an alternative and equally preferred embodiment, the reinforcing panel element is positioned between a first folding line and a second folding line opposite the outer edge of the blank with respect to the first folding line. Preferably, the reinforcing panel element is positioned between the first folding line and the second folding line, without further folding lines being interposed between the reinforcing panel element and the first line. Preferably, the reinforcing panel element corresponds to a second panel element, defined by the first folding line and by the second folding line of the blank.

Preferably, the reinforcing panel element has an extension in a direction perpendicular to the movement plane that is less than an extension in the direction perpendicular to the movement plane of the other panel elements of the blank.

Preferably, the reinforcing panel element has a surface area less than a surface area of any other panel element of the blank.

Preferably, a folding line of the blank comprises a reinforcing adhesion portion.

Preferably, the reinforcing adhesion portion comprises an adhesive strip. Preferably, the adhesive strip comprises a hot melt glue and/or a water-based adhesive.

Preferably, it is provided for applying the reinforcing adhesion portion on the blank before folding the protective portion.

Preferably, it is provided for applying the reinforcing adhesion portion by means of one or more gluing devices.

Preferably, the reinforcing adhesion portion is superimposed on a folding line of the blank.

Preferably, the reinforcing adhesion portion is interposed between two further folding lines.

Preferably, the reinforcing adhesion portion is at a median folding line of the blank.

Preferably, the median folding line has an equal number of further folding lines interposed towards both ends of the blank.

Preferably, it is provided for adhering the reinforcing panel element onto the reinforcing adhesion portion, to fix a structure of the protective portion.

Preferably, the reinforcing panel element adhering on the reinforcing adhesion portion is positioned diagonally in a section of the protective portion on the movement plane.

Preferably, it is provided for adhering an edge of the reinforcing panel element in abutment on the reinforcing adhesion portion.

Preferably, the rotation axis of the retainer remains parallel to the folding lines of the blank, during the movement of the retainer.

Preferably, the rotation of the retainer around the rotation axis is actuated with an angular speed such as to keep a relative orientation of the retainer with respect to lines tangent to each circular arc unchanged.

Preferably, the rotation of the retainer around the rotation axis is actuated with an angular speed such as to keep the retainer substantially tangent to each circular arc.

Preferably, the circular arcs define a continuous trajectory of the retainer.

Preferably, the continuous trajectory of the retainer comprises a plurality of circular arcs connected to each other by a plurality of trajectory connections.

Preferably, the plurality of trajectory connections exhibits cusps.

Preferably, the plurality of circular arcs is equal in number to the number of the plurality of folding lines.

Preferably, the circular arcs define a respective plurality of centres. Preferably, the centres of the circular arcs lie on the movement plane.

Preferably, each circular arc of the plurality of circular arcs has a constant radius of curvature.

Preferably, each circular arc of the plurality of circular arcs has a radius of curvature substantially corresponding to a distance between a geometric centre of the retainer on the movement plane and a folding line at which the respective centre of each circular arc is located.

Preferably, a section of the retainer in the movement plane remains aligned to a direction parallel to lines tangent to each circular arc.

Preferably, the section of the retainer in the movement plane remains substantially tangent to each circular arc.

Preferably, the retainer is movable on the movement plane in a first direction perpendicular to the lying plane. Preferably, the retainer is movable on the movement plane in a second direction parallel to the lying plane. Preferably, the movement of the retainer along the circular arcs results from a combination of movements in the first direction and in the second direction.

Preferably, the retainer comprises at least one rotatable joint defining the rotation axis. Preferably, the at least one rotatable joint is at the geometric centre of the retainer, on the movement plane.

Preferably, the retainer comprises two respective rotatable joints. Preferably, the movement plane is interposed between the two respective rotatable joints.

Preferably, it is provided for releasing the retainer from the retaining portion of the blank, once the folding of the protective portion is completed.

Preferably, it is provided for releasing the retainer from the retaining portion by means of a releasing movement of the retainer.

Preferably, the releasing movement of the retainer is perpendicular to the movement plane.

Preferably, the retainer is switchable to a release condition in which the retainer does not retain the blank at the retaining portion.

Preferably, the retainer is further movable in a release direction that is perpendicular to the movement plane.

Preferably, when the retainer is in the release condition, it can disengage from the blank by moving along the release direction.

Preferably, the retainer comprises at least one gripper element.

Preferably, the retaining portion is substantially parallel to the folding lines of the blank.

Preferably, the retaining portion comprises a strip portion of the blank.

Preferably, the retaining portion is smaller than any panel element of the plurality of panel elements of the blank.

Preferably, the retaining portion is positioned between a first folding line and an outer edge of the blank.

Preferably, the retaining portion is positioned between the first folding line and the outer edge, without further folding lines being interposed between the retaining portion and the outer edge.

Preferably, the retaining portion is positioned in a first panel element, defined by the first folding line and by the outer edge of the blank.

Preferably, the retaining portion is positioned in the reinforcing panel element.

Preferably, a section of the retaining portion in the movement plane remains aligned to a direction perpendicular to lines tangent to each circular arc along which the retainer translates.

Preferably, a section of the retaining portion in the movement plane is substantially tangent to each circular arc along which the retainer translates.

Preferably, the retainer comprises a pair of retaining elements.

Preferably, the pair of retaining elements are respectively associated with a pair of rotatable joints.

Preferably, the pair of rotatable joints defines the rotation axis of the retainer.

Preferably, each retaining element comprises a respective gripper element.

Preferably, each retaining element retains a respective end of the retaining portion.

Preferably, each retaining element has a respective development axis, parallel to the rotation axis.

Preferably, the gripper element has a respective development axis, parallel to the rotation axis.

Preferably, the retainer grasps opposite surfaces of the blank.

Preferably, the gripper element grasps the blank by retaining it from both of its opposite surfaces.

Preferably, the opposite surfaces of the blank face onto opposite directions with respect to the lying plane of the blank.

Preferably, the gripper element comprises a pair of elongated straight gripper jaws.

Preferably, the gripper jaws are aligned with the rotation axis of the rotatable joint of the retainer.

In an alternative and equally preferred embodiment, the gripper jaws may be non-aligned with the rotation axis of the rotatable joint of the retainer. In this case, preferably, the gripper jaws are eccentric on the rotatable joint of the retainer.

Preferably, the gripper jaws are parallel to the rotation axis of the rotatable joint of the retainer.

Preferably, in the operating condition, the retaining portion of the blank is interposed between the pair of gripper jaws.

Alternatively, the retainer comprises a vacuum retaining element. Preferably, the vacuum retaining element is connected to a pneumatic vacuum source, and retains the retaining portion by pneumatic suction effect.

Preferably, it is provided for positioning a contrasting element at at least a folding line of the blank.

Preferably, the contrasting element is positioned at the at least one folding line before moving the retainer along each circular arc.

Preferably, each circular arc has its respective centre at the at least one folding line.

Preferably, the contrasting element moves on the movement plane in a first direction. Preferably, the first direction is perpendicular to the lying plane.

Preferably, the contrasting element moves on the movement plane in a second direction. Preferably, the second direction is parallel to the lying plane.

Preferably, the second direction is perpendicular to the first direction. Preferably, the first direction is perpendicular to the second direction. Preferably, the first direction and the second direction are perpendicular to each other.

Preferably, the contrasting element rests at folding lines of the blank, to promote its folding.

The Applicant has perceived that, while a folding is performed by the movable retainer, the stiffness of the blank astride a folding line may cause other portions of the blank to tend to follow the movement of the retaining portion, deforming the blank undesirably and worsening the folding quality.

The Applicant has therefore found that a movable contrasting element, which positions itself on a folding line before the movement of the retainer for folding around the same folding line, allows to stabilize the blank and to improve the quality of the protective portion.

Preferably, the contrasting element has a corner contrasting surface. Preferably, the corner contrasting surface defines a square portion on a section along the movement plane. Preferably, the corner of the square portion rests at folding lines of the blank. Preferably, the corner contrasting surface has a straight development in a direction perpendicular to the movement plane.

Preferably, the contrasting element comprises an arched body that develops parallel to the lying plane. Preferably, the arched body develops in a cantilevered manner. Preferably, the arched body defines a closed perimeter trajectory with an internal opening.

Preferably, the contrasting element has a development dimension in a direction perpendicular to the movement plane that is greater than an extension in the direction perpendicular to the movement plane of the blank.

Preferably, there is provided a pusher element which is moved in a direction perpendicular to the lying plane.

Preferably, the pusher element pushes against the blank.

Preferably, it is provided for moving the pusher element against the blank, in

proximity of at least one folding line of the blank.

Preferably, the pusher element is moved during the movement of the retainer along each circular arc having the respective centre at the at least one folding line.

Preferably, it is provided for positioning the contrasting element at the at least one folding line of the blank, before moving the pusher element against the blank.

Preferably, the pusher element moves crossing the lying plane to push on the blank.

The Applicant has verified that the movable pusher element in a direction perpendicular to the lying plane promotes the correct folding of the blank during the movement of the movable retainer, rising itself and accompanying the blank portion in the rotation around the folding line.

Preferably, the pusher element acts at all the respective folding lines of the blank, while folding the protective portion.

Preferably, the pusher element provides a tapered pushing surface. Preferably, the tapered pushing surface defines a curved portion on a section along the movement plane. Preferably, the tapered pushing surface has a straight development in a direction perpendicular to the movement plane.

Preferably, the pusher element provides a lateral containment surface. Preferably, the lateral containment surface is a flat surface. Preferably, the lateral containment surface is arranged perpendicular to the lying plane.

The Applicant has also verified that, once the pusher element has reached a raised position beyond the lying plane, the lateral containment surface contributes to containing the blank portion already folded and to keeping it in position for the subsequent folding steps.

Preferably, the lateral containment surface acts on the folded blank. Preferably, the lateral containment surface acts on a panel element of the blank.

Preferably, it is provided a folder system that moves on the movement plane at least in a direction parallel to the lying plane.

Preferably, the folder system pushes on the blank. Preferably, the folder system pushes, at least with one of its elements, on the blank.

Preferably, the blank is folded on itself to form the protective portion in a space delimited by a side of the lying plane which is opposite to the side in which the folder system moves in a direction parallel to the lying plane.

Preferably, the folder system comprises the pusher element. Preferably, the folder system comprises a support element.

Preferably, the support element provides at least one rest surface of the lying plane.

Preferably, the blank lies with at least a portion thereof on the rest surface of the support element.

Preferably, the pusher element moves at least in a direction perpendicular to the lying plane, independently of the support element.

Preferably, there is provided a pressor element that pushes on folded portions of the blank.

Preferably, the pressor element moves on the movement plane, in a direction perpendicular to the lying plane and further in a direction parallel to the lying plane.

The Applicant has verified that the pressor element promotes the correct folding of the blank during the movement of the movable retainer, lowering itself and accompanying the blank portion in the rotation around the folding line.

The Applicant has also verified that the pressor element contributes to maintaining a correct folding of the blank during the alternation of the folding steps.

Preferably, the pressor element is positioned in the space delimited by one side of the lying plane, where the blank is raised and folded on itself to form the protective portion.

Preferably, the pressor element is positioned on an opposite side of the lying plane with respect to the side on which the folder system moves.

Preferably, the pressor element pushes at least one panel element against a respective adhesion portion of the blank.

Preferably, the pressor element indirectly pushes a panel element against the respective panel adhesion portion.

Preferably, the pressor element directly pushes an edge of the reinforcing panel element against the respective reinforcing adhesion portion.

The Applicant has verified that the pressor element contributes to improving the bonding of the folded blank portions, when they come into contact with the respective adhesion portions.

Preferably, it is provided for releasing the retainer from the retaining portion of the blank while the pressor element continues to push on the blank.

Preferably, the pressor element has a tapered pressor surface. Preferably, the tapered pressor surface defines a curved portion on a section along the movement plane. Preferably, the tapered pressor surface has a straight development in a direction perpendicular to the movement plane.

Preferably, the pressor element is configured to engage within the contrasting element, beyond the corner contrasting surface.

Preferably, there is provided a fixed retainer which retains the blank distally from the retaining portion.

The Applicant has verified that the fixed retainer allows to stabilize the position of the blank during the movement of the movable retainer, improving the folding of the various elements around the respective folding lines.

Preferably, there is provided a control system of the apparatus.

Preferably, the control system controls the movement and/or rotation of the retainer.

Preferably, the control system controls the movement of the contrasting element.

Preferably, the control system controls the movement of the folder system and/or of the support element and/or of the pusher element.

Preferably, the control system controls the movement of the pressor element.

Preferably, the control system is operatively connected to a determination unit. Preferably, the determination unit detects a format of the blank and generates at least format information.

Alternatively, an operator provides an indication for said at least format information.

Preferably, the control system controls the movement of the apparatus based on the at least format information.

The Applicant has verified that the movement of the various devices of the apparatus, for example the movement and rotation of the retainer, are adaptable to the format of the blank and to the dimensions of the protective portion to be formed, so that the apparatus can effectively handle variations in the format of the blank when required.

Further features and advantages of the present invention will result from the following detailed description of one or more embodiments thereof, provided by way of non-limiting example.

The detailed description will be made with reference to the attached drawings, in which:

### BRIEF DESCRIPTION OF THE DRAWINGS

- FIG. 1 illustrates an exemplary embodiment of an apparatus for forming a protective portion from a blank according to the present invention.

- FIG. 2 illustrates an exemplary embodiment of blank usable in the apparatus of FIG. 1.

- FIG. 3 illustrates a side sectional view of the blank of FIG. 2, folded to form a protective portion.

- FIG. 4 illustrates a detailed view of the apparatus of FIG. 1, from a first point of view.

- FIG. 5 illustrates a detailed view of the apparatus of FIG. 1, from a second point of view.

- FIGS. 6 to 20 illustrate subsequent folding steps of a blank, in an exemplary embodiment of an apparatus for forming a protective portion according to the present invention.

- FIG. 21 illustrates the evolution of the movement of a retainer according to the present invention, during the folding steps of the blank referred to in FIGS. 5 to 20.

In the different figures, analogous elements will be identified by analogous reference numbers. In some views, where several analogous elements are present, only one or some of them will be denoted by a respective reference, meaning that the others are still included in the discussion.

### DETAILED DESCRIPTION

In the figures, an apparatus, according to the present invention, for forming a protective portion, for example starting from a blank 100 which will be further described, is indicated as a whole by reference 10.

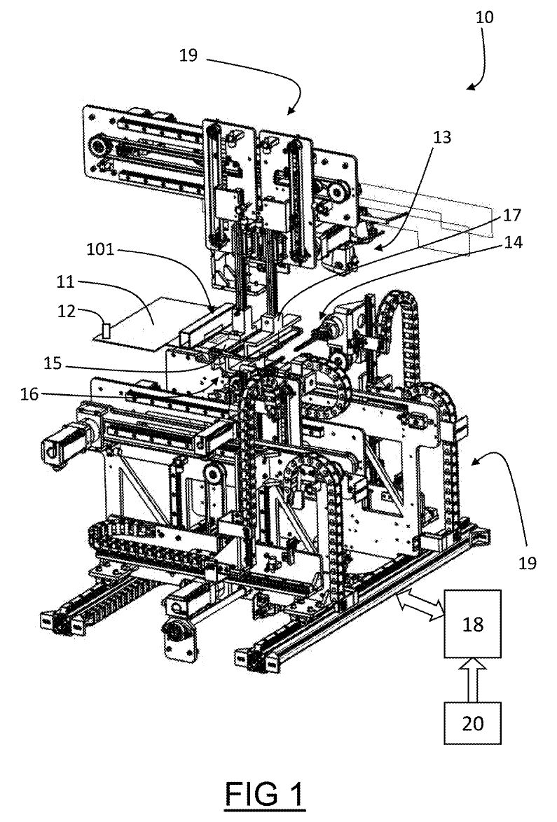

The apparatus 10 is illustrated in FIG. 1 in a simplified form; in fact, some supports and guides that allow the load-bearing structure of the apparatus 10 to be made are omitted, in order to improve the visibility of the elements of the present invention.

The apparatus 10 comprises a lying surface 11 defining a lying plane on which a blank to be folded can rest, and which in the example has already been folded to form the protective portion 101 which will be further described.

In proximity of the lying surface 11, the apparatus 10 comprises a fixed retainer 12, here schematized as a simple square, which for example can be realized by means of one or more retaining brackets possibly put into operation by suitable actuators. The fixed retainer 12 is able to retain the blank in a stable position on the lying surface 11. In this way, the blanks can be subjected to folding processing without moving in an unwanted manner.

The apparatus 10 comprises one or more gluing devices 13 which are movable on respective guides parallel to the lying plane and transverse to the blank. The gluing devices 13 distribute adhesion portions, consisting for example of strips of hot glue and/or water-based adhesive, on the surface of the blank, before folding it.

The apparatus 10 comprises a retainer 14 adapted to retain a portion of the blank by means of retaining elements which will be further described. The retainer 14 is movable and moves the retaining portion of the blank with it, causing it to fold.

The apparatus 10 comprises a contrasting element 15 adapted to be positioned at folding lines of the blank, to facilitate folding. The contrasting element 15 is movable to be positioned each time on an appropriate folding line, for the purposes of the correct folding of the blank.

The apparatus 10 comprises a folder system 16 adapted to push the blank in proximity of folding lines of the blank, to facilitate its folding. The folder system 16 is movable to be positioned each time below the blank at an appropriate folding line, for the purposes of the correct folding of the blank. The folder system 16 in turn comprises further elements which will be described later.

The apparatus 10 comprises a pressor element 17 adapted to push on folded portions of the blank, to facilitate its folding and to stabilize the protective portion during processing. The pressor element 17 is movable to be positioned each time above the blank at appropriate panel elements, for the purposes of correct folding of the blank.

The apparatus 10 comprises a control system, schematized by block 18, adapted to control the operation, in particular the movement, of the various elements of the apparatus 10.

The apparatus 10 comprises a plurality of actuators 19 configured to confer appropriate degrees of freedom to the various elements of the apparatus 10, in particular allowing the movement of the gluing devices 13, of the retainer 14, of the contrasting element 15, of the folder system 16 and of the pressor element 17.

Such plurality of actuators 19 comprises linear guides and rotatable guides, pulley and belt systems and relative actuators or electric motors, controlled by the control system 18. The plurality of actuators 19 is not described in greater detail here for brevity, since there may be various solutions, per se within the reach of the person skilled in the art, which would be capable of providing to the various elements of the apparatus 10 the appropriate degrees of freedom as described below.

The apparatus 10 comprises a determination unit 20, operatively connected to the control system 18. The determination unit 20 is configured to detect a format of the blank 100 and provide a format indication to the control system 18, based on which to control the appropriate movement made by the plurality of actuators 19. In fact, blanks having different dimensions require different folding movements, and therefore the movement made by the plurality of actuators 19 must be adjusted based on the desired movement of the various elements of the apparatus 10.

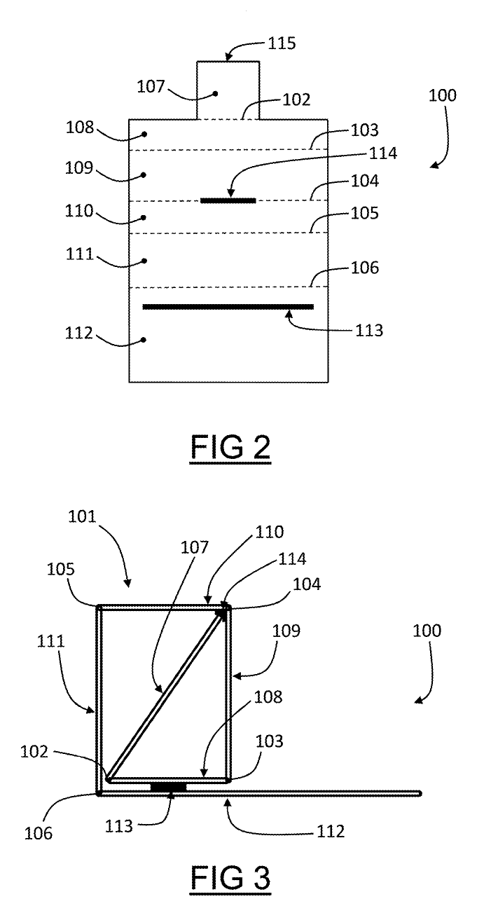

FIG. 2 illustrates a blank 100 in a flat and unfolded condition, lying on a lying plane that coincides with the plane of the sheet. FIG. 3 instead illustrates the blank in a folded condition, constituting the protective portion 101 presented in a cross section of the blank 100, perpendicular to the lying plane of FIG. 2.

The blank 100 comprises five folding lines 102, 103, 104, 105 and 106 which are creases, made in a previous processing step of the blank 100.

The folding lines 102, 103, 104, 105 and 106 define a respective plurality of panel elements 107, 108, 109, 110, 111 and 112 of the blank 100.

There is a first panel element 107 and a last panel element 112, which are delimited respectively by individual folding lines 102 and 106; the other panel elements 108, 109, 110 and 111 are delimited by two folding lines each.

The blank 100 comprises a panel adhesion portion 113 applied to the base panel element 112. In the protective portion 101, the panel element 108 is made to adhere in a planar manner to the panel adhesion portion 113, to form a rectangular-section structure.

The blank 100 comprises a reinforcing adhesion portion 114, applied superimposed to the folding line 104. The folding line 104 is median, being interposed between the other folding lines with two folding lines 102 and 103 on one side, and two folding lines 105 and 106 on the other side. In the protective portion, the panel element 107 constitutes a reinforcing panel element 107 positioned diagonally in the rectangular-section structure of the protective portion 101.

The reinforcing panel element 107 contributes to the structural strength of the protective portion 101 by mechanically reinforcing it. The reinforcing panel element 107 may have smaller dimensions than the other panel elements, since its function is to provide a diagonal reinforcement that may not involve the entire width dimension of the protective portion 101, when folded.

The reinforcing panel element 107 is adhered in abutment with a free edge 115 thereof on the reinforcing adhesion portion 114, so as to stabilize the structure of the protective portion 101.

The panel adhesion portion 113 and the reinforcing adhesion portion 114 are applied to the blank 100 before folding which will be described later.

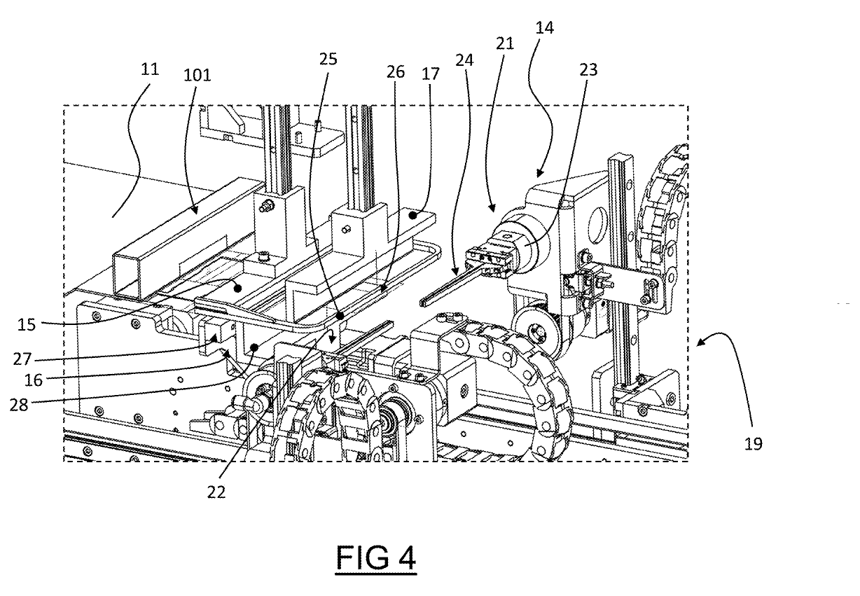

In the enlargements of FIG. 4 and FIG. 5, the following can be seen in greater detail: the retainer 14, the contrasting element 15, the folder system 16 and the pressor element 17.

The retainer 14 comprises a pair of retaining elements 21 and 22, adapted to retain the blank from two opposite sides. The retaining elements 21 and 22 are substantially symmetrical to each other, and the structure of the retaining element 21 alone will be described in detail, it being understood that the retaining element 22 has similar features.

The retaining element 21 is rotatable around a rotatable joint 23. Therefore, the retaining element 21 can both move by translating, and rotate around its own rotation axis defined by the rotatable joint 23.

The retaining element 21 comprises a gripper element 24, having a pair of straight and elongated gripper jaws. The gripper element 24 is configured to retain a retaining portion of the blank, as will be further described, when the gripper jaws are closed in the operating condition depicted herein. The gripper jaws can also open, in a release condition, being able to disengage from the blank.

The gripper jaws of the gripper element 24 are aligned with the rotation axis defined by the rotatable joint 23, so that when the retaining element 21 is rotated, it rotates in alignment with the development axis of the retaining element 21 itself.

The contrasting element 15 comprises an arched body 25 which develops in cantilevered manner and which defines an internal opening adapted to allow the passage of the pressor element 17, as depicted in FIG. 4.

The arched body 25 defines a corner contrasting surface 26 which develops on a straight line and is adapted to interact with the folding lines of the blank.

The folder system 16 comprises a support element 27 which contributes, together with the lying surface 11, to defining the lying plane for the blank.

The folder system 16 then comprises a pusher element 28 movable in a direction perpendicular to the lying plane and adapted to cross it to push on the blank.

The pressor element 17 is positioned in the space delimited by the side of the lying plane where the blank is raised and folded on itself to form the protective portion.

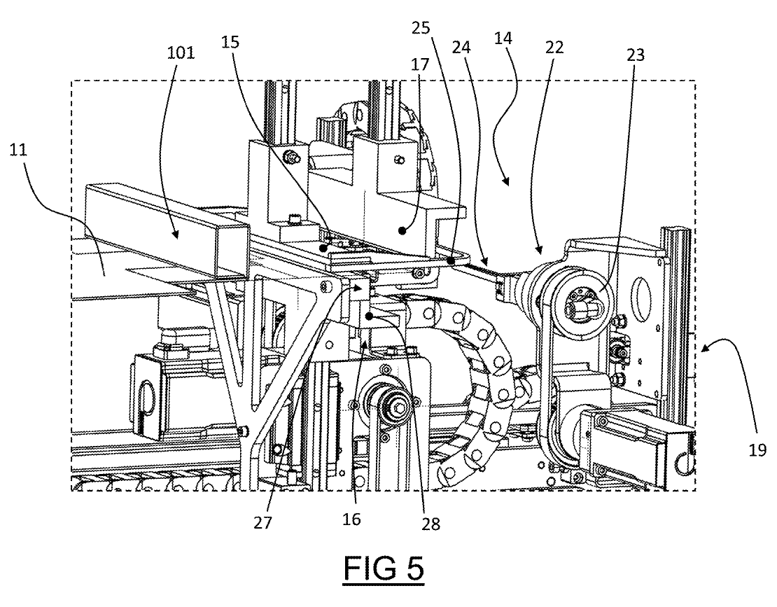

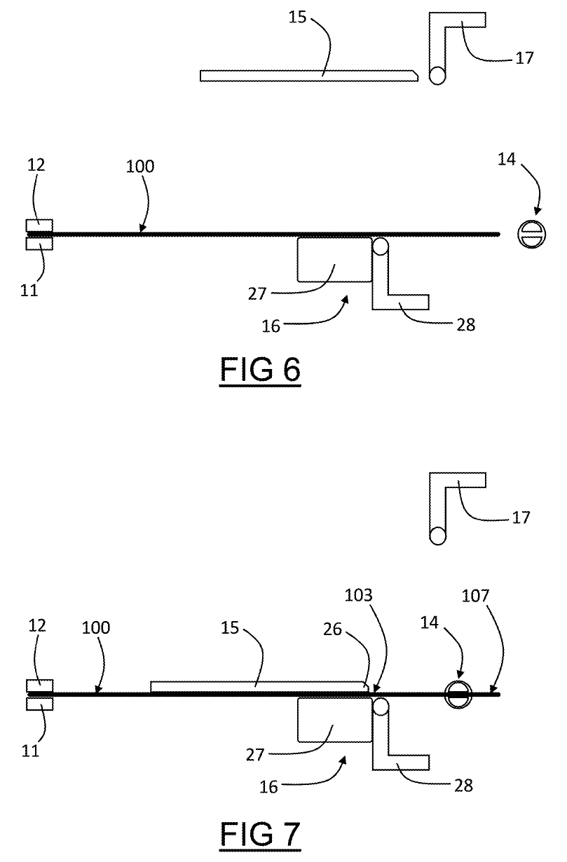

In FIG. 6 and in the following figures, the blank 100 is schematically depicted in the various steps of formation of the protective portion. The various elements of the apparatus 10, i.e. the retainer 14, the contrasting element 15, the folder system 16 and the pressor element 17, also schematically depicted, are movable on a movement plane that is perpendicular to the lying plane on which the blank 100 is located. In these examples, the movement plane of the various elements corresponds to the plane of the sheet.

The blank 100 is arranged on the lying plane, supported by the lying surface 11 and by the support element 27. The blank 100 is retained at one end by the fixed retainer 12, for the subsequent performance of the folding processing.

In FIG. 7, the contrasting element 15 moves in a first direction, in this example a horizontal direction, and in a second direction perpendicular to the first, in this example a vertical direction, on the movement plane to bring a square portion of its corner contrasting surface 26 at the folding line 103 of the blank 100.

The folder system 16 moves parallel to the lying plane and below the blank 100, bringing itself at the same folding line 103.

The retainer 14 moves bringing itself at the reinforcing panel element 107 of the blank 100, and grasps a retaining portion thereof by closing the retaining elements 21 and 22 in operating condition. The retaining portion of the blank 100, thus grasped, is retained by the retainer 14 for the entire performance of the folding of the protective portion 101.

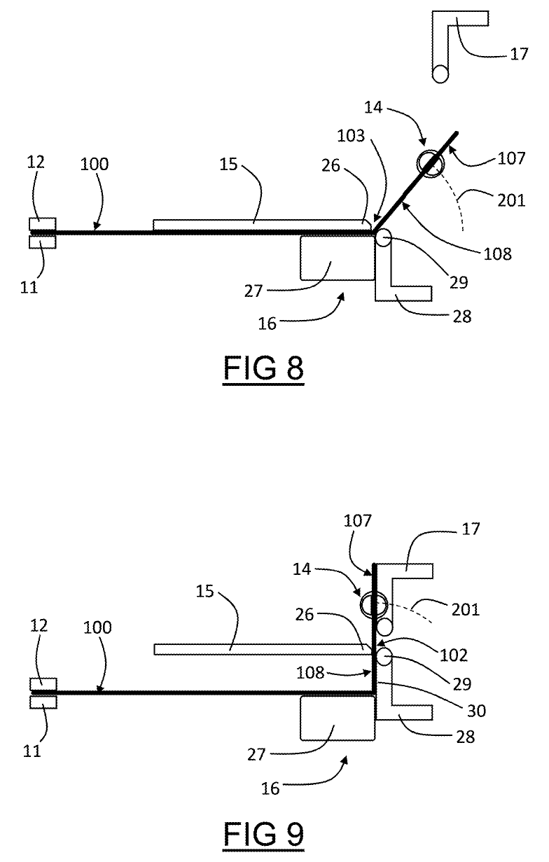

In FIG. 8, the retainer 14 moves along a first section of a circular arc 201, performing a simultaneous rotation around its own rotation axis. The panel elements 107 and 108 of the blank 100 are folded around the folding line 103, on which the centre of the circular arc 201 is located.

Simultaneous with the movement and rotation of the retainer 14, the pusher element 28 of the folder system 16 rises and crosses the lying plane of the blank 100. The pusher element 28 cooperates and promotes the folding around the folding line 103, pushing in proximity thereof with its own tapered pushing surface 29 having a curved portion, which accompanies the movement of the blank 100 imposed by the retainer 14.

In FIG. 9, the retainer 14 moves along a second section of the circular arc 201, performing a simultaneous rotation around its own rotation axis. The panel elements 107 and 108 of the blank 100 are further folded around the folding line 103, until reaching a configuration perpendicular to the lying plane.

Simultaneous with the movement and rotation of the retainer 14, the pusher element 28 rises further, resting its own lateral containment surface 30 on the panel element 108, containing it.

Furthermore, the contrasting element 15 moves at least in the second direction, in this example the vertical direction, in the movement plane to bring its own corner contrasting surface 26 opposite to the tapered pushing surface of the movable pusher element 28. The corner contrasting surface 26 is thus located in proximity of the folding line 102 of the blank 100.

Further, the pressor element 17 moves in a direction perpendicular to the lying plane, in this example a vertical direction, and further in a direction parallel to the lying plane, in this example in a horizontal direction, bringing itself into contact with the surface of the panel element 107 which has been folded to become perpendicular to the lying plane.

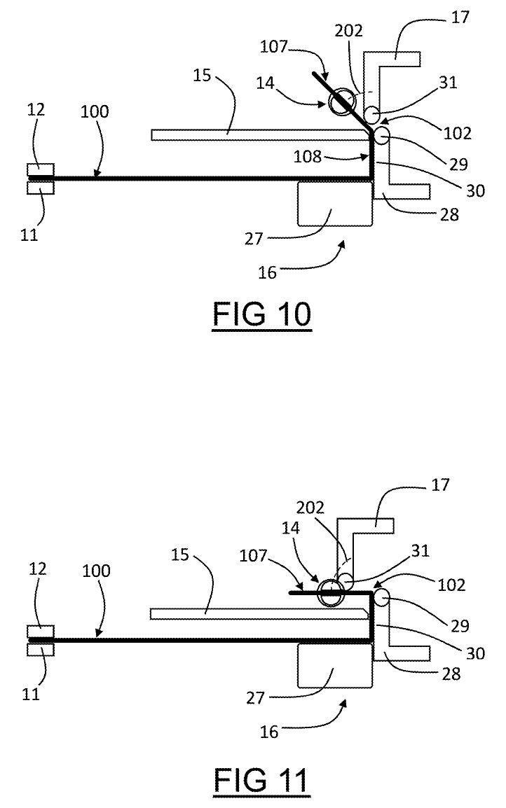

In FIG. 10, the retainer 14 moves along a first section of a circular arc 202, performing a simultaneous rotation around its own rotation axis. The panel element 107 of the blank 100 is folded around the folding line 102, on which the centre of the circular arc 202 is located.

Simultaneous with the movement and rotation of the retainer 14, the pusher element 28 of the folder system 16 rises further, to promote the folding of the panel element 107 around the folding line 102, pushing in proximity thereof with the tapered pushing surface 29.

Simultaneous with the movement and rotation of the retainer 14, the pressor element 17 moves in the direction parallel to the lying plane, in this example in the horizontal direction, remaining in contact and pushing the panel element 107 with its own tapered pressor surface 31 having a curved portion, promoting the folding of the panel element 107 around the folding line 102.

In FIG. 11, the retainer 14 moves along a second section of the circular arc 202, performing a simultaneous rotation around its own rotation axis. The panel element 107 of the blank 100 is further folded around the folding line 102, until reaching a configuration parallel to the lying plane.

Simultaneous with the movement and rotation of the retainer 14, the contrasting element 15 moves at least in the second direction, in this example the vertical direction, on the movement plane to lower itself and not to interfere with the movement of the retainer 14. The own corner contrasting surface 26 of the contrasting element remains opposite the lateral containment surface 30 of the movable pusher element 28, with the already folded panel element 108 interposed.

The pusher element 28 can be raised further, remaining rested with its lateral containment surface 30 on the panel element 108, containing it.

Simultaneous with the movement and rotation of the retainer 14, the pressor element 17 moves at least in the direction perpendicular to the lying plane, in this example in the vertical direction, and further in the direction parallel to the lying plane, in this example in the horizontal direction, remaining in contact and pushing the panel element 107 with its tapered pressor surface 31, promoting the folding of the panel element 107 around the folding line 102.

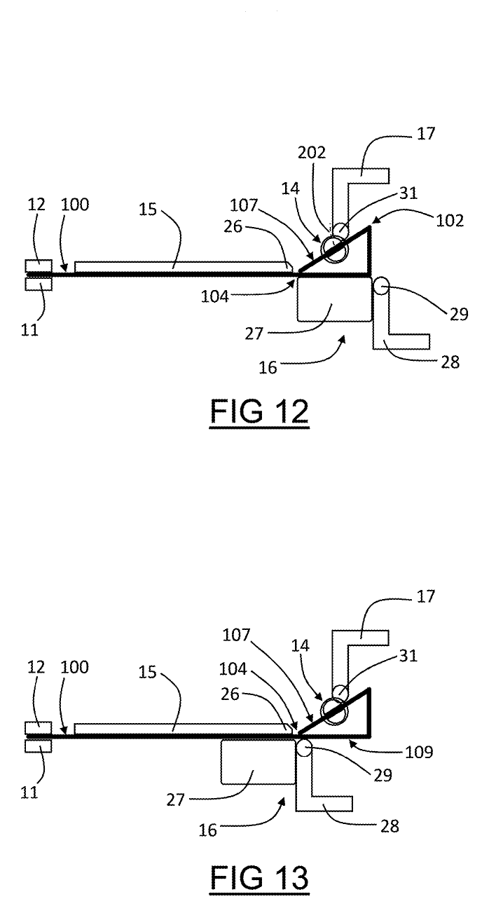

In FIG. 12, the retainer 14 moves along a third section of the circular arc 202, performing a simultaneous rotation around its own rotation axis. The panel element 107 of the blank 100 is further folded around the folding line 102, until reaching an angled configuration with respect to the lying plane, which will correspond to a diagonal position in the protective portion 101.

The contrasting element 15 moves in the first direction, in this example the horizontal direction, and in the second direction, in this example the vertical direction, in the movement plane to lower itself and not to interfere with the movement of the retainer 14. The contrasting element 15 brings a square portion of its corner contrasting surface 26 at the folding line 104 of the blank 100, for subsequent processing steps.

The pusher element 28 can be lowered, releasing the panel element 108. The pusher element 28 moves back within the space delimited by the lying plane in which the support element 27 is also located.

Simultaneous with the movement and rotation of the retainer 14, the pressor element 17 moves at least in the direction perpendicular to the lying plane, in this example in the vertical direction, and further in the direction parallel to the lying plane, in this example in the horizontal direction, remaining in contact and pushing the panel element 107 with its tapered pressor surface 31, promoting the folding of the panel element 107 around the folding line 102.

In FIG. 13, the retainer 14, the contrasting element 15 and the pressor element 17 remain in the previously assumed positions.

The folder system 16 moves parallel to the lying plane and below the blank 100, bringing itself at the folding line 104, where the corner contrasting surface 26 of the contrasting element 15 is already located.

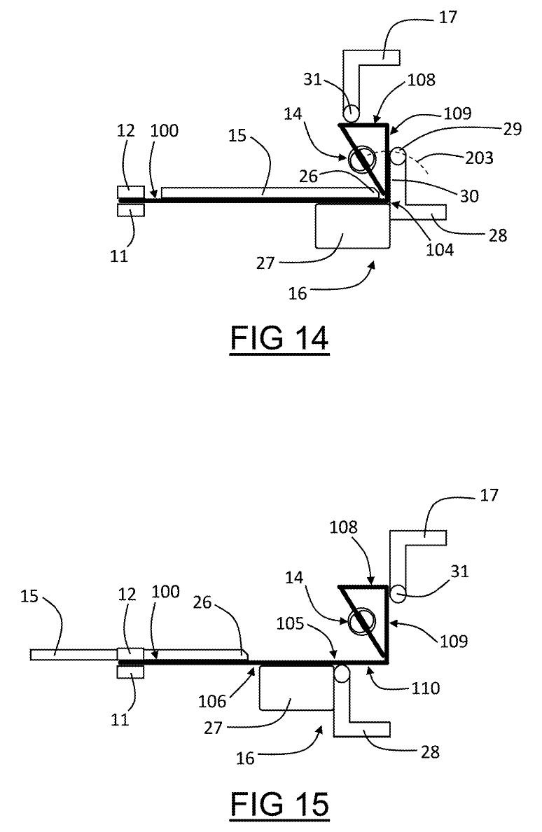

In FIG. 14, the retainer 14 moves along a circular arc 203, performing a simultaneous rotation around its own rotation axis. The panel element 109 of the blank 100 is folded around the folding line 104, on which the centre of the circular arc 203 is located.

Simultaneous with the movement and rotation of the retainer 14, the pusher element 28 of the folder system 16 rises and crosses the lying plane of the blank 100. The pusher element 28 cooperates and promotes the folding around the folding line 104, pushing in proximity thereof with the tapered pushing surface 29, which accompanies the movement of the blank 100 imposed by the retainer 14.

Simultaneous with the movement and rotation of the retainer 14, the pressor element 17 moves in both movement directions in the direction perpendicular to the lying plane, in this example in the vertical direction, and further in the direction parallel to the lying plane, in this example in the horizontal direction, to return in contact and push on the previously folded panel element 108. In this way, the tapered pressor surface 31 of the pressor element 17 indirectly pushes the reinforcing panel element 107 against the reinforcing adhesion portion 114 already described, which is located at the folding line 104.

In FIG. 15, the retainer 14 remains in the previously assumed position.

The contrasting element 15 moves in the first direction, in this example the horizontal direction, to bring the square portion of its corner contrasting surface 26 substantially at the folding line 106 of the blank 100, for subsequent processing steps. The contrasting element 15 is schematized as being superimposed on the fixed retainer 12, but this is only a schematization, and there is no interference between the two elements.

The folder system 16 moves parallel to the lying plane and below the blank 100, bringing itself at the folding line 105.

Further, the pressor element 17 moves in a direction perpendicular to the lying plane, in this example a vertical direction, and further in a direction parallel to the lying plane, in this example in a horizontal direction, bringing itself into contact with the surface of the panel element 109 which has been folded to become perpendicular to the lying plane.

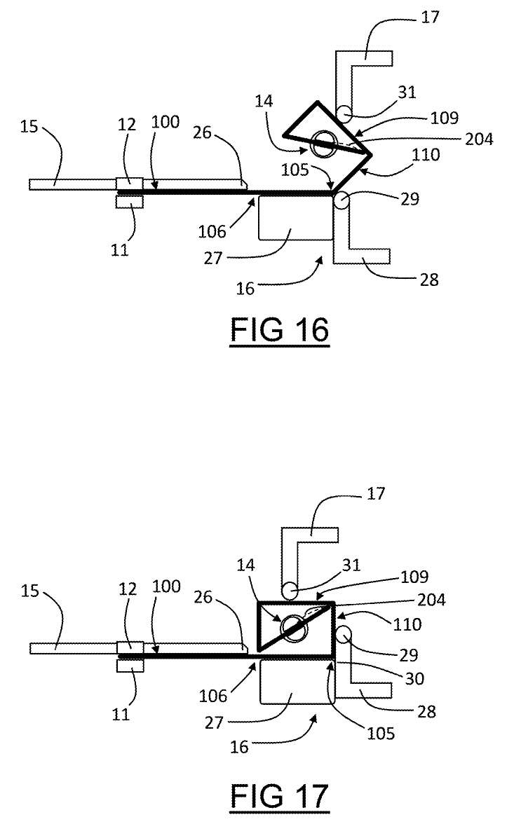

In FIG. 16, the retainer 14 moves along a first section of a circular arc 204, performing a simultaneous rotation around its own rotation axis. The panel element 110 of the blank 100 is folded around the folding line 105, on which the centre of the circular arc 204 is located.

Simultaneous with the movement and rotation of the retainer 14, the pusher element 28 of the folder system 16 rises slightly, to promote the folding of the panel element 110 around the folding line 105, pushing in proximity thereof with the tapered pushing surface 29.

Simultaneous with the movement and rotation of the retainer 14, the pressor element 17 moves at least in the direction parallel to the lying plane, in this example in the horizontal direction, remaining in contact and pushing the panel element 109 with the tapered pressor surface 31, promoting the folding of the panel element 110 around the folding line 105.

In FIG. 17, the retainer 14 moves along a second section of the circular arc 204, performing a simultaneous rotation around its own rotation axis. The panel element 110 of the blank 100 is further folded around the folding line 105, on which the centre of the circular arc 204 is located.

Simultaneous with the movement and rotation of the retainer 14, the pusher element 28 of the folder system 16 rises further and promotes the folding around the folding line 105, pushing in proximity thereof with the tapered pushing surface 29, which accompanies the movement of the blank 100 imposed by the retainer 14. In addition, the pusher element 28 rests its lateral containment surface 30 on the panel element 110, containing it.

Simultaneous with the movement and rotation of the retainer 14, the pressor element 17 moves in the direction perpendicular to the lying plane, in this example in the vertical direction, and further in the direction parallel to the lying plane, in this example in the horizontal direction, to push further on the panel element 109 with the tapered pressor surface 31, promoting the folding of the panel element 110 around the folding line 105.

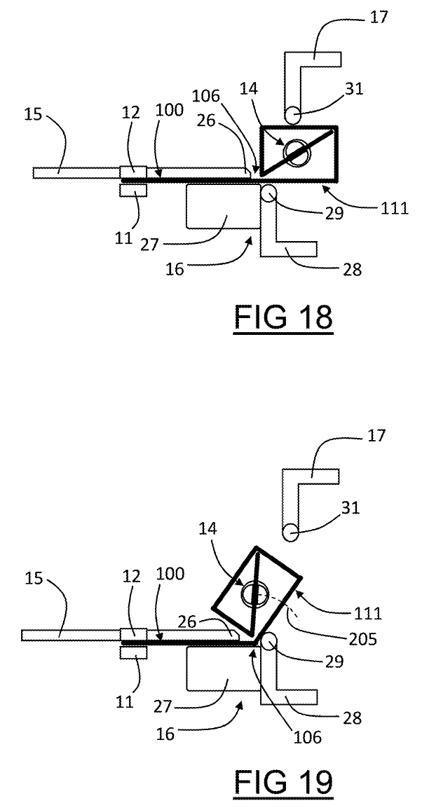

In FIG. 18, the retainer 14, the contrasting element 15 and the pressor element 17 remain in the previously assumed positions. It should be noted that a suitable offset of the corner contrasting surface 26 with respect to the folding line 106 at which it is located is provided, to allow folding the protective portion without hindrance.

The folder system 16 moves parallel to the lying plane and below the blank 100, bringing itself at the folding line 106, where the corner contrasting surface 26 of the contrasting element 15 is already located.

In FIG. 19, the retainer 14 moves along a first section of a circular arc 205, performing a simultaneous rotation around its own rotation axis. The panel element 11 of the blank 100 is folded around the folding line 106, on which the centre of the circular arc 205 is located.

Simultaneous with the movement and rotation of the retainer 14, the pusher element 28 of the folder system 16 rises and crosses the lying plane of the blank 100. The pusher element 28 cooperates and promotes the folding around the folding line 106, pushing in proximity thereof with the tapered pushing surface 29, which accompanies the movement of the blank 100 imposed by the retainer 14.

Before or simultaneous with the movement and rotation of the retainer 14, the pressor element 17 moves in the direction perpendicular to the lying plane, in this example in the vertical direction, and further in the direction parallel to the lying plane, in this example in the horizontal direction, to move away from the blank 100 and avoid hindering the folding.

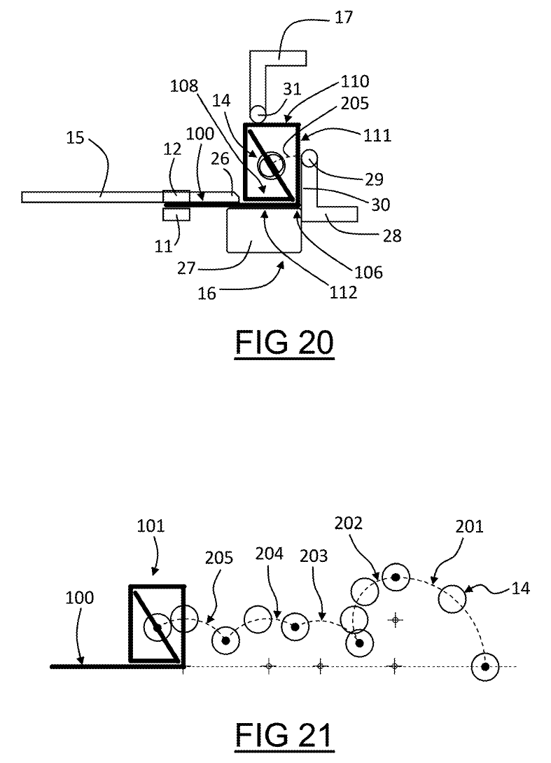

In FIG. 20, the contrasting element 15 moves in the first direction, in this example the horizontal direction, for the square portion of its corner contrasting surface 26 substantially outside the work zone, so as not to hinder the folding of the protective portion 101.

The retainer 14 moves along a second section of the circular arc 205, performing a simultaneous rotation around its own rotation axis. The panel element 111 of the blank 100 is further folded around the folding line 106, on which the centre of the circular arc 205 is located.

Simultaneous with the movement and rotation of the retainer 14, the pusher element 28 of the folder system 16 rises further and promotes the folding around the folding line 106, pushing in proximity thereof with the tapered pushing surface 29, which accompanies the movement of the blank 100 imposed by the retainer 14. In addition, the pusher element 28 rests its lateral containment surface 30 on the panel element 111, containing it.

The pressor element 17 moves in the direction perpendicular to the lying plane, in this example in the vertical direction, and further in the direction parallel to the lying plane, in this example in the horizontal direction, to return in contact and push on the previously folded panel element 110. In this way, the tapered pressor surface 31 of the pressor element 17 indirectly pushes the panel element 108 against the panel adhesion portion 113 already described, applied to the base panel element 112.

In this way, the structure of the protective portion 101 is formed and stabilized. The retainer 104 can exit from the operating condition and move to the release condition, disengaging from the blank 100. The fixed retainer 12 may also release the blank, which comprises the protective portion 101 thus formed.

FIG. 21 schematizes the movement of the retainer 14 accompanying the retaining portion of the blank, at the reinforcing panel element 107 as described above. The dashed straight line schematically shows the lying plane, on which the blank 100 lies before folding.

The circular arcs 201, 202, 203, 204 and 205 along which the retainer 14 moves define a trajectory in the movement plane that allows folding the blank 100.

The rotation of the retainer 14 causes it to move while remaining tangent to the circular arcs 201, 202, 203, 204 and 205, allowing accurate rotation of the blank 100 without unwanted twisting or deformation.

At the end of the folding movement promoted by the retainer 14, the protective portion 101 is formed from the blank 100.

1. An apparatus for forming a protective portion from a blank, said apparatus comprising:
a lying plane for said blank;
a retainer switchable to an operating condition in which said retainer retains said blank at a retaining portion of said blank;
wherein said retainer is movable on a movement plane perpendicular to said lying plane,
wherein said retainer is further rotatable around a rotation axis perpendicular to said movement plane,
wherein said rotation axis passes through said retaining portion,
wherein said retainer is configured to translate along circular arcs on said movement plane while rotating around said rotation axis and while it is in said operating condition, actuating a folding of said blank.

2. The apparatus according to claim 1, wherein said retainer comprises a pair of retaining elements, each retaining element of said pair of retaining elements having a respective development axis parallel to said rotation axis.

3. The apparatus according to claim 2, wherein said retainer is configured to grasp opposite surfaces of said blank, retaining said retaining portion.

4. The apparatus according to claim 1, wherein said apparatus further comprises a contrasting element,
wherein said contrasting element is configured to move in a first direction on said movement plane, and is further configured to move in a second direction on said movement plane, said second direction being perpendicular to said first direction,
and wherein said contrasting element is configured to rest at folding lines of said blank, to promote said folding.

5. The apparatus according to claim 1, wherein said apparatus further comprises a folder system configured to push on said blank,
wherein said folder system is configured to move on said movement plane in at least one direction parallel to said lying plane.

6. The apparatus according to claim 5, wherein said folder system further comprises:
a support element configured to provide a rest surface of said lying surface;
a pusher element configured to move on said movement plane in at least one direction perpendicular to said lying plane independently of said support element;
and wherein said pusher element is configured to cross said lying plane in order to push on said blank.

7. The apparatus according to claim 1, wherein said apparatus further comprises a pressor element,
wherein said pressor element is configured to move on said movement plane in a direction perpendicular to said lying plane and further in a direction parallel to said lying plane,
and wherein said pressor element is configured to push on folded portions of said blank.

8. The apparatus according to claim 1, wherein said apparatus further comprises a fixed retainer configured to retain said blank distally from said retaining portion.

9. A method of forming a protective portion from a blank, said method comprising:
identifying a plurality of folding lines of said blank, said folding lines being parallel to each other;
retaining said blank by means of a retainer at a retaining portion of said blank;
moving said retainer along a plurality of successive circular arcs having respective centres at said folding lines;
simultaneous to moving said retainer along each circular arc of said plurality of circular arcs, said each circular arc having a respective centre, rotating said retainer around a rotation axis which remains parallel to a folding line of said folding lines at said respective centre, wherein said rotation axis is passing through said retaining portion of said blank.

10. The method according to claim 9, wherein said method further comprises:
releasing said retainer from said retaining portion of said blank, once said folding of said protective portion is completed, by a releasing movement of said retainer, said releasing movement being perpendicular to a movement plane of said retainer.

11. The method according to claim 9, wherein said method further comprises:
moving a pusher element against said blank in a direction perpendicular to said lying plane and in proximity of at least one folding line of said plurality of folding lines of said blank, while moving said retainer along said each circular arc having said respective centre at said at least one folding line.

12. The method according to claim 9, wherein said method further comprises:
positioning a contrasting element at at least one folding line of said blank, before moving said retainer along said each circular arc having said respective centre at said at least one folding line.

13. The method according to claim 12, wherein said method further comprises:
moving a pusher element against said blank in a direction perpendicular to said lying plane and in proximity of at least one folding line of said plurality of folding lines of said blank, while moving said retainer along said each circular arc having said respective centre at said at least one folding line; wherein positioning said contrasting element at said at least one folding line is actuated before moving said pusher element against said blank.

14. The method according to claim 9, wherein said method further comprises:
pushing on folded portions of said blank with a pressor element and releasing said retainer from said retaining portion of said blank.

15. The method according to claim 9, wherein said retainer grasps opposite surfaces of said blank, retaining said retaining portion.

16. The method according to claim 9, wherein said blank rests on a rest surface of a support element, defining a lying plane for said blank,
wherein said retainer is movable on a movement plane perpendicular to said lying plane,
wherein said retainer is further rotatable around a rotation axis perpendicular to said movement plane,
wherein said retainer translates along circular arcs on said movement plane while rotating around said rotation axis.

17. The method according to claim 16, wherein said movement plane is perpendicular to said folding lines of said blank.

18. The method according to claim 9, wherein the plurality of folding lines defines a respective plurality of panel elements of the blank,
wherein a first panel element of the plurality of panel elements comprises a panel adhesion portion,
wherein a second panel element of the blank is adhered onto the panel adhesion portion, to fix a structure of the protective portion.

19. The method according to claim 18, wherein the panel adhesion portion is applied on the first panel element before folding the protective portion,
and wherein the first panel element is positioned between a last folding line of the blank and an outer edge of the blank.

20. The method according to claim 9, wherein the plurality of successive circular arcs defines a continuous trajectory of the retainer,and wherein the plurality of successive circular arcs is equal in number to the number of the plurality of folding lines.
